(19) United States
(12) Patent Application Publication
(10) Pub. No.: US 2011/0083582 A1
(43) Pub. Date: Apr. 14, 2011

(54) PIGMENT MIXTURE OF PVD ALUMINIUM EFFECT PIGMENTS AND THIN ALUMINIUM EFFECT PIGMENTS FROM MILLING, PROCESS FOR PREPARATION THEREOF AND USE THEREOF

(76) Inventors: Diana Wagner, Hersbruck (DE); Christian Rummer, Nurnberg (DE); Robert Maul, Winkelhaid (DE); Klaus Greiwe, Lauf (DE)

(21) Appl. No.: 12/997,291

(22) PCT Filed: Jun. 25, 2009
(86) PCT No.: PCT/EP2009/004582

§ 371 Date: Dec. 10, 2010

(30) Foreign Application Priority Data
Jun. 25, 2008 (DE) 10 2008 029 821.2

(51) Int. Cl. C09D 11/02; C04B 14/34

(52) U.S. Cl. 106/31.9; 106/401

(57) ABSTRACT

A mixture of aluminum effect pigments, the mixture comprising:
a) PVD aluminum effect pigments (PVD Al) which, in a thickness distribution as determined via thickness counting by scanning electron microscopy (SEM) and represented as cumulative frequency distribution, have an H_{50,PVD} value in a range from 10 nm to 7 nm,
b) aluminum effect pigments (conv.-Al) which have been produced by milling methods and, in a thickness distribution as determined via thickness counting by scanning electron microscopy (SEM) and represented as cumulative frequency distribution, have an h_{50,conv.} value in a range from 15 nm to 100 nm, and
c) a solvent or solvent mixture,
with the proviso that the weight ratio of PVD Al to conv. Al is 99:1 to 1:99 and the solvent content is at least 30% by weight, based on the total weight of the mixture. The disclosure further relates to a process for preparing the mixture and to the use of the mixture.

The invention relates to a mixture of aluminum effect pigments, to a process for preparing them, and to their use.

Aluminum effect pigments produced by PVD processes (PVD: physical vapor deposition) have been available commercially for approximately 20 years. In optical terms they represent the highest grade of aluminum effect pigments. These pigments have average thicknesses of below 60 nm and relatively narrow thickness distributions. On account of the way in which they are produced, their surfaces are very smooth and uniform.

Examples of products available commercially include Metalure® (Avery, sold through Eckart), Metasheen® (Ciba Specialities), Decomet® (Schlenk) or Starbrite® (Silberline).

Ready-made printing inks comprising PVD aluminum pigments are available from Eckart under the trade name Ultra Star®.

On account of their strong propensity to agglomeration, the PVD pigments are available commercially as dilute dispersions in organic solvents, with a pigment content of only 5% up to a maximum of 20% by weight. These commercial forms therefore have a very high organic solvent fraction. In light of the efforts worldwide to reduce VOC, this is a distinct disadvantage of such pigments.

Moreover, PVD pigments fluctuate relatively widely in their optical properties in the application media. One of the reasons for this is the complex production technology. Moreover, optically very high-grade pigments may also be correspondingly susceptible to fluctuations.

US 2003/0178734 A1 describes an improved production process for producing PVD aluminum pigments.

Aluminum pigments produced by PVD methods are those having in optical terms the most sophisticated properties. In recent years, however, success has been achieved, by wet milling of atomized aluminum powder, in producing aluminum effect pigments which come close to the low thickness of the PVD pigments.

EP 1 621 586 A1 discloses aluminum effect pigments having sizes d₅₀ of 8 μm to 30 μm and average thickness of 25 to 80 nm that have been produced by wet milling.

WO 2004/087816 A2 likewise discloses very thin aluminum effect pigments produced by milling. These aluminum effect pigments have a span of the thickness distribution of 70% to 140%. In terms of their optical properties, these pigments are situated between the PVD pigments and the so-called “silver dollar” pigments. These “silver dollar” pigments are conventional aluminum effect pigments, obtained by milling, that have substantially greater thicknesses, usually situated within the range from about 150 nm to about 500 nm.

Also known, from WO 2005/118722 A1, are thin aluminum pigments, produced by milling, which have been given an inorganic anticorrosion coat.

It is an object of the present invention to provide aluminum effect pigments which have similar high-grade properties to PVD pigments and yet have a lower solvent content and a more consistent processing quality.

It is a further object of the invention to find a process for producing the aluminum effect pigments of the invention.

The object has been achieved by provision of a mixture of aluminum effect pigments which comprises

a) PVD aluminum effect pigments (PVD Al) which in a thickness distribution as determined via thickness counting by scanning electron microscopy (SEM) and represented as cumulative frequency distribution have an H_{50,PVD} value from a range from 10 nm to 70 nm,
b) aluminum effect pigments (conv. Al) which have been produced by milling methods and in a thickness distribution as determined via thickness counting by scanning electron microscopy (SEM) and represented as cumulative frequency distribution have an h_{50,conv.} value from a range from 15 nm to 100 nm,
c) solvent or solvent mixture,
with the proviso that the weight ratio of PVD Al to conv. Al is 99:1 to 1:99 and the solvent content is at least 30% by weight, based on the total weight of the mixture.

The object on which the invention is based is further achieved by provision of a process for preparing the inventive mixture of aluminum effect pigments, said process comprising the following step:

mixing PVD aluminum effect pigments (PVD Al) and aluminum effect pigments produced by milling (conv. Al), in the presence of solvent or a solvent mixture.

The object of the invention is further achieved through the use of the inventive mixture of aluminum effect pigments in coatings, paints, printing inks, plastics or cosmetic formulations, and also by the provision of a coating composition which comprises a mixture of aluminum effect pigments as claimed in any of claims 1 to 11, and by a coated article which has or comprises a coating composition as claimed in claim 14 or a mixture of aluminum effect pigments as claimed in any of claims 1 to 11.

Preferred developments of the invention are indicated in the respective dependent claims.

The abbreviation “PVD Al” refers in the present context to aluminum effect pigments produced by PVD (physical vapor deposition).

The abbreviation “conv. Al” refers in the present context to aluminum effect pigments produced by milling methods.

PVD aluminum effect pigments have an almost absolutely planar surface. As a result of their production, the PVD aluminum effect pigments have relatively straight fracture edges along the outer pigment periphery. In the production of PVD aluminum pigments, aluminum is generally applied by vapor deposition to a support belt and is detached thereafter. In the course of detachment, the film of aluminum breaks up into smaller fragments, which thereafter can be comminuted further. The relatively straight fracture edges come about in the course of detachment and also of the optional further comminution.

The aluminum pigments produced by deformational milling (conv. Al) differ from PVD pigments in having an irregularly shaped marginal region. The irregularly shaped marginal region comes about in the course of production, through the mechanical action of grinding media, typically balls, on the atomized aluminum powder which is the starting material for producing aluminum effect pigments by milling. Furthermore, the aluminum effect pigments produced by deformational milling do not have an almost absolutely planar surface. In contradistinction to PVD aluminum pigments, the conv. Al pigments obtained by milling exhibit slight depressions and elevations.

The differences between PVD aluminum effect pigments and aluminum effect pigments produced by milling (conv. Al) are very readily apparent under the SEM (scanning electron microscope).

In preferred embodiments the weight ratio of PVD Al to conv. Al is 95:5 to 5:95, more preferably 90:10 to 10:90, and very preferably 80:20 to 20:80. It is also possible, however, of course, to use mixtures in which the weight ratio is in the range from 60:40 to 40:60.

As conventionally produced aluminum effect pigments it is possible to make use, for example, of the aluminum effect pigments described in EP 1 621 586 A1 and WO 2004/087816 A2. Those specifications are hereby incorporated by reference.

In the context of this invention, the thickness distribution of the metallic effect pigments has been determined by means of scanning electron microscopy (SEM). This method requires the measurement of a sufficient number of particles to allow a representative statistical evaluation. Typically around about 100 particles are subjected to measurement.

The thickness distribution is usefully represented in the form of a cumulative frequency distribution, also referred to as cumulative frequency plot or cumulative undersize curve. An appropriate average value is the h₅₀ value of the cumulative frequency distribution. One measure of the coarse fraction is the h₉₀ value. It expresses the possession, by 90% of all of the pigment particles, of a thickness equal to this value and/or below this value. Correspondingly, for example, an h₉₈ value expresses the possession, by 98% of all of the pigment particles, of a thickness equal to this value and/or below this value. Similarly, the h₁₀ value is a measure of the fine fraction of the thickness distribution, and expresses the possession, by 10% of all the pigments particles, of a thickness equal to this value and/or below this value.

These values may be determined arithmetically from a list of the individual values measured, with the aid, for example, of the quantile function in an Excel representation. Determination of the thicknesses of the individual pigments by means of SEM takes place in accordance with the technique described in WO 2004/087816 A2.

In preferred embodiments the aluminum effect pigments produced by milling methods (conv. Al) have an h_{50,conv.} value from a range from 20 nm to 75 nm, more preferably 22 nm to 65 nm, very preferably 23 nm to 55 nm, and with particular preference from 25 nm to 50 nm.

Aluminum effect pigments (conv. Al) having an h_{50,conv.} value from these preferred ranges are especially suitable for use in printed applications where so-called film reverse applications are produced. By these are meant the application of a printed ink pigmented with aluminum effect pigments, such as a gravure or screen printing ink, for example, to a largely trans-parent film. When the print is subsequently viewed through the film, a metallic mirror is formed of a kind which is otherwise unachievable with conventional effect pigments. To date, PVD aluminum effect pigments have always been used for film reverse applications.

For these film reverse applications in particular it is preferred for the aluminum effect pigments overall to have a thickness distribution within a very thin range. Thicker pigments may be disrupt the orientation and therefore lessen the mirror effect associated with extremely high gloss.

In preferred embodiments, therefore, the aluminum pigments produced by milling methods (conv. Al) have an h_{90,conv.} value as determined via thickness counting by scanning electron microscopy from a range from 30 nm to 110 nm, more preferably from 32 nm to 100 nm, very preferably from 33 nm to 90 nm, and with particular preference from 35 nm to 75 nm.

Aluminum effect pigments produced by PVD methods preferably have the same thickness distributions.

In preferred embodiments, furthermore, the aluminum pigments produced by milling methods (conv. Al) have a relative breadth of the thickness distribution, Δh, as determined via thickness counting by scanning electron microscopy and calculated on the basis of the corresponding cumulative frequency distribution of the relative frequencies according to the formula

$$Δ h = 100 \times \frac{{h}_{90} - {h}_{50}}{{h}_{50}} ,$$

of 20% to 140%.

In particularly preferred embodiments the aluminum effect pigments produced by milling methods have a relative breadth of the thickness distribution, Δh, in a range from 30% to below 70%. With further preference the relative breadth of the thickness distribution, Δh, is situated in a range from 35% to 67%, more preferably from 40% to 65%, and very preferably from 40% to 60%.

In particularly preferred embodiments the aluminum effect pigments of the mixture overall, i.e., of PVD Al and conv. Al, have a relative breadth of the thickness distribution, Δh, in a range from 20% to below 70%, more preferably from 25% to 67%, very preferably from 27% to 65%, and with particular preference from 30% to 60%.

Aluminum effect pigments produced by wet milling and having an h_{50,conv.} of 15 to 80 nm with a thickness span of below 70% were hitherto unobtainable.

In the production of these aluminum effect pigments, the starting material used is fine atomized aluminum powder with a narrow particle size distribution.

The process for producing the aluminum effect pigments for use in accordance with the invention is notable for its extremely gentle deformational milling of atomized aluminum powder. Specifically, the process comprises the following steps:
a) providing an atomized aluminum powder having a particle size distribution which preferably has a d_{powder,Al,10}<3.0 μm, a d_{powder,Al,50}<5.0 μm, and a d_{powder,Al,90}<8.0 μm,
b) milling the atomized aluminum powder from step a) using a milling mechanism, in the presence of solvent and lubricants and grinding media which preferably have an individual weight of 2 to 13 mg.

The atomized aluminum powder is produced preferably in atomizers by atomization or nozzle spraying of liquid aluminum, preferably of an aluminum melt. The atomized powder comprises or consists of aluminum particles having a preferably largely round form. It is particularly preferred to use atomized aluminum powders having aluminum particles in a spherical to slightly ellipsoidal form. In accordance with one preferred variant, the aluminum powder obtained from atomization of an aluminum melt is classified in order to give the desired particle size distribution, which may also be referred to as particle band.

The atomized aluminum powder is preferably a very fine metal powder with a very narrow size distribution. The particle band of the size distribution is determined conventionally by laser diffraction spectrometry, the particle size being ascertainable from the scattering of the laser light. The laser diffraction spectrometry can be performed, for example, with the Helos instrument from Sympatec GmbH, Clausthal-Zellerfeld, Germany, in accordance with manufacturer details.

The size distribution preferably has a d_{powder,Al,10}<3.0 μm, a d_{powder,Al,50}<5.0 μm, and a d_{powder,Al,90}<8.0 μm. More preferably the size distribution comprises a d_{powder,Al,10}<0.6 μm, a d_{powder,Al,50}<2.0 μm, and a d_{powder,Al,90}<4.0 μm.

Following the atomizing step, the powder can be brought to the desired narrow size distribution by means of corresponding classifying steps. Classifying may be performed with air classifiers, cyclones, and other known devices.

These fine and relatively narrow-range atomized aluminum powders are especially suitable for producing the aluminum effect pigments to be used in accordance with the invention. As a lower limit, the size distribution preferably has the following characteristics: d_{powder,Al,10}>0.15 μm, d_{powder,Al,50}>0.8 μm, and d_{powder,Al,90}>2.0 μm. The atomized aluminum powder used, therefore, is predominantly not aluminum powder in nanometric dimensions.

Further preference is given to atomized aluminum powders having a d_{powder,Al,50} value range from 0.9 to 3.0 μm and even more preferably from 0.95 to 2.5 μm.

These atomized aluminum powders used with preference preferably have a span of their size distribution, defined conventionally as

Δd_{powder,Al}=(d_{powder,Al,90}−d_{powder,Al,10})/d_{powder,Al,50},

of 30% to 200% and more preferably of 40% to 1800, and very preferably of 50% to 170%.

The use of such a fine atomized aluminum powder of narrow size distribution is extremely advantageous for the production of the aluminum effect pigments obtained by milling (conv. Al) and intended for use in accordance with the invention.

During the deformational milling, the deformation of the aluminum powder particles is not completely uniform: this means that certain particles are deformed to a greater extent, while some of the powder particles are not deformed until a very late stage during the milling procedure. Among the reasons for this is the fact that the deformation probability of a particle is dependent on its size. Hence particles which have already undergone preliminary deformation to form flakes have a higher specific area than powder which has not yet been deformed, and, accordingly, have a higher probability of being deformed further. The breadth of the size distribution of the powder, therefore, is transposed not only into the size distribution of the aluminum flakes formed from it, but also into the distribution of the thickness distribution. For narrow thickness distributions, therefore, it is necessary to use an atomized aluminum powder with a corresponding low size variation.

The purity of the aluminum used for the atomization is preferably 99.0% to more than 99.9% by weight. The powder may comprise, in correspondingly small amounts, the typical alloying constituents, such as Mg, Si, Fe, for example.

The atomized aluminum powder is milled using a milling mechanism, preferably a ball mill with or without an agitator mechanism, in the presence of solvent and lubricants as grinding assistants, and of grinding media, which have an individual weight of 1.2 to 13 mg. On account of the extremely gentle mode of milling, this milling procedure takes a comparatively long time. The milling time is preferably 15 to 100 h, preferably 16 to 80 h, and more preferably 17 to 70 h.

According to one preferred development of the invention the grinding media have an individual weight of 2.0 to 12.5 mg and more preferably 5.0 to 12.0 mg. Grinding media used are preferably spherical media, more preferably balls.

Preferred balls are those having a very smooth surface, a form which is as round as possible, and a largely uniform size. The ball material may be of steel, glass or ceramic, such as zirconium oxide or corundum, for example. The temperatures during the milling operation are preferably in the range from 10° C. to 70° C. Preferred are temperatures in a range from 25° C. to 45° C.

Particularly preferred are balls made of glass and having an average weight of 2.0 to 12.5 mg.

Additionally preferred are balls of steel having an average individual weight of 1.2 to 4.5 mg and more preferably an average individual weight of 1.4 to 4.0 mg, and also, with further particular preference, an average individual weight of 2.0 to 3.5 mg.

The long milling times lead to a large number of pigment-ball impacts. As a result of these impacts the pigment is shaped very uniformly, developing a very smooth surface and a very narrow thickness distribution.

The rotational speeds of the ball mill are preferably 25% to 68%, more preferably 28% to 60%, and with particular preference 30% to below 50%, and with further particular preference, 35% to 45% of the critical speed n_{crit}.

In relation to milling in a ball mill, the critical speed n_{crit} is an important parameter, indicating the point in time at which the centrifugal forces press the balls against the mill wall, and there is virtually no milling any longer:

$${n}_{crit} = \sqrt{\frac{g}{2 {π}^{2}} \cdot \frac{1}{D}}$$

where D is the drum diameter and g is the gravitational constant.

Low rotational speeds promote slow deformation of the atomized aluminum powder. In order to bring about slow deformation, additionally, lightweight grinding balls are preferably used in the process of the invention. Grinding balls having an individual weight of more than 13 mg may deform the atomized aluminum powder too greatly, and this can lead to premature fracture.

In contrast to conventional milling processes, the atomized aluminum powder in this process is predominantly not milled or comminuted, but instead is deformed very gently over a relatively long time period.

Milling with very lightweight balls in conjunction with low speeds and a long milling time results in extremely gentle milling, producing very thin aluminum pigments. Since the atomized aluminum powder used has a very narrow particle size distribution, the aluminum effect pigments of the invention also have a very uniform thickness distribution.

Milling may take place in a solvent, with a weight ratio of solvent to atomized aluminum powder of 2.5 to 10 and with a weight ratio of the grinding balls to atomized aluminum powder of 20-110, and with lubricants as grinding assistants.

There are a large number of compounds that can be used as lubricants in the course of milling.

Included in this context are the long-established fatty acids used with alkyl radicals of 10 to 24 C atoms. Preference is given to using stearic acid, oleic acid or mixtures thereof.

Stearic acid as a lubricant results in leafing pigments, while oleic acid leads to nonleafing pigments.

Leafing pigments are characterized in that in an application medium, as for example a coating or printing ink, they float, i.e., they take up a disposition at the surface of the application medium. Nonleafing pigments, on the other hand, take up a disposition in the application medium. The fatty acids may additionally be admixed with long-chain amino compounds, for example.

The fatty acids can be animal or else vegetable in origin. Likewise, organic phosphonic acids and/or phosphoric esters can be used as lubricants.

The diameter of the aluminum effect pigments, d_{50,M}, in the mixture according to the invention (i.e., of PVD Al and conv. Al) is 5 to 50 μm. This size distribution is determined typically by laser granulometry. The d_{50,M} value of the aluminum effect pigments in the mixture is preferably 13 to 40 μm and more preferably 15 to 30 μm.

In one particularly preferred embodiment the mixture of PVD aluminum (PVD Al) and conventional aluminum (conv. Al) effect pigments according to the invention is not per se a coating, paint, cosmetic or printing ink—in other words, the mixture according to the invention is not as such ready for possible use as a coating, paint, printing ink or cosmetic.

The mixture according to the invention of aluminum effect pigments can, however, be used for producing coating compositions, such as coatings, paints, printing inks or cosmetics. The mixture according to the invention in this case can be incorporated into existing coating, paint, and printing ink systems or cosmetics.

In the context of the aforementioned preferred embodiment, the mixture of aluminum effect pigments according to the invention is instead a precursor product, which has a solvent content of preferably 53% to 88% by weight and a metallic effect pigment fraction of preferably 45% to 12% by weight, based in each case on the total weight of the mixture. The solvent content of this precursor product of the invention is preferably 60% to 87% by weight and more preferably 65% to 85% by weight, based in each case on the total weight of the mixture. The precursor product is preferably a paste or a dispersion, but preferably this precursor product has a pasty consistency.

In any given case, the solvent content may be dependent on the solvent content of the starting materials used and on the mixing proportion. The solvent content of commercially customary PVD aluminum effect pigments is typically 95% to 80% by weight.

In the case of the thin, conventionally milled aluminum effect pigments, the solvent content is higher when the pigments become thinner. The reason for this, of course, is the increase in specific surface area that accompanies the drop in flake thickness and that therefore entails an increased demand for organic solvents in order to attain a pastelike consistency. Hence the solvent contents in the case of the conventional aluminum effect pigments are typically between 40% and 70% by weight, preferably between 50% and 65% by weight.

In accordance with one preferred variant of the invention, aluminum effect pigments (conv. Al) which are obtained by milling that are used are those which are disclosed in WO 2004/087816 A2, and hereby incorporated by reference.

Preference is given in accordance with the invention to aluminum effect pigments which in a thickness distribution as determined via thickness counting by scanning electron microscopy (SEM) and represented as a cumulative frequency distribution have an h_{Al,50} value from the range from 15 to 150 nm.

With further preference the aluminum effect pigments have an h_{Al,50} value from the range from 15 to 100 nm, more preferably from 15 to 80 nm, very preferably from 16 to 60 nm, and with further preference from 17 to 55 nm.

Aluminum effect pigments which have proven very suitable are those which in a thickness distribution as determined via thickness counting by scanning electron microscopy (SEM) and represented as a cumulative frequency distribution have an h_{Al,50} value from the range from 30 to below 100 nm.

According to one variant of the invention, the aluminum effect pigments obtained by milling (conv. Al) that are used exhibit leafing behavior, i.e., they are oriented at or near to the surface of the application medium—a paint, printing ink or coating, for example.

According to one variant of the invention, the aluminum effect pigments obtained by milling (conv. Al) that are used exhibit nonleafing behavior, i.e., they are oriented near to the substrate surface in the application medium—a paint, printing ink or coating, for example.

In the case of reverse applications in particular it is preferred for the aluminum effect pigments for use in accordance with the invention, obtained by milling (conv. Al) and the PVD aluminum effect pigments, to exhibit nonleafing behavior.

In the case of one preferred embodiment both the PVD aluminum effect pigment and the aluminum effect pigment obtained by milling (conv. Al) in the aluminum effect pigment mixture have very low pigment thicknesses.

In the case of one preferred embodiment all of the aluminum effect pigments in the aluminum effect pigment mixture of the invention have overall an h_{M,50} value of to 100 nm, preferably of 20 to 80 nm, and more preferably of 20 to 60 nm. These values relate to all of the aluminum effect pigments in the mixture, and are also independent of the mixing proportion of the two components.

In the aluminum effect pigment mixture of the invention, the PVD aluminum effect pigments and the aluminum effect pigments obtained by milling (conv. Al) may have a different leafing or nonleafing behavior relative to one another. For instance, the PVD aluminum effect pigments may have a nonleafing behavior and the aluminum effect pigments obtained by milling (conv. Al) may have a leafing behavior, or vice versa.

According to one preferred embodiment, the PVD aluminum effect pigments and the aluminum effect pigments obtained by milling (conv. Al) both have leafing behavior or both have nonleafing behavior. Very preferably the PVD aluminum effect pigments and the aluminum effect pigments obtained by milling (conv. Al) both have nonleafing behavior.

In the preparation of the inventive mixture of aluminum effect pigments, the PVD aluminum effect pigments and the aluminum effect pigments obtained by milling (conv. Al) are mixed with one another in a solvent. Instead of a solvent it is also possible to use a solvent mixture. Preferably both the PVD aluminum effect pigment and the aluminum effect pigment obtained by milling (conv. Al) are present in the form of a paste or dispersion prior to mixing.

The mixture according to the invention is preferably in a low-dust or dust-free form. In this case the solvent content may be in a range from 30% up to 90% by weight, based on the total weight of the mixture. The solvent content is preferably in a range from 40% to 80% by weight, more preferably from 50% to 70% by weight.

It has emerged, surprisingly, that the inventive mixture of aluminum effect pigments allows the use of a smaller fraction of solvent than was hitherto possible when dispersing with PVD aluminum effect pigment.

Surprisingly, the aluminum effect pigment mixture of the invention, following application, has optical properties, particularly in respect of lightness, gloss, and flop, which come very close to those of an applied pure PVD aluminum effect pigment preparation.

The aluminum effect pigment mixture of the invention therefore allows a significant reduction in the VOC content (VOC: volatile organic compound(s)) in aluminum effect pigment preparations.

It is thought that the aluminum effect pigments obtained by milling (conv. Al) that are present in the mixture according to the invention counteract the agglomeration of PVD aluminum pigments that normally occurs. Without wishing to be tied to one theory, it is supposed that the slightly irregular surface and/or irregularly formed marginal regions, as compared with PVD aluminum pigments, of the aluminum effect pigments obtained by milling (conv. Al) have the effect that, in the mixture according to the invention, the PVD aluminum effect pigments do not come to lie against one another over their full area and hence are unable to agglomerate. The aluminum effect pigments obtained by milling (conv. Al), therefore, act as “spacers”, counteracting full-area contact of PVD aluminum effect pigments. As a result of the aluminum effect pigments obtained by milling (conv. Al) that are present in the aluminum effect pigment mixture of the invention, there is presumably, predominantly, pointwise contact, and hence a distinct reduction in full-area contact between PVD aluminum pigments.

It will be appreciated that, in addition to the PVD aluminum effect pigments and the aluminum effect pigments obtained by milling (conv. Al), there may also be further effect pigments present, such as other metallic effect pigments, pearlescent effect pigments, chromatic pigments, color pigments, etc., in the mixture according to the invention.

According to one variant of the mixture according to the invention, the mixture of pigments contains exclusively PVD aluminum effect pigments and aluminum effect pigments obtained by milling (conv. Al).

The formulations of the invention are preferably coatings, powder coatings, paints, printing inks, and cosmetics, preferably nail varnishes.

The coated articles are preferably vehicle bodies, facing elements, window frames, or finger- and toenails.

In further embodiments of the invention the mixture of aluminum effect pigments further comprises binders.

Serving as binders may be, for example, those based on polyurethanes, polyamides, polyureas, melamine binders, polyimides, polyacrylates, polymethacrylates, epoxy binders, polyethers and/or polyesters. Also possible is the use of combinations of these functionalities, such as, for example, polyester-polyurethanes or polyester-polyether-polyurethanes, polyester-polyacrylates or polyacrylate-polyurethanes.

The ratio of the weight fractions of aluminum effect pigments to binder is 8:1 to 1:15, preferably 6:1 to 1:10, and more preferably 1:2 to 1:5.

In this context, high aluminum effect pigment/binder ratios are to refer preferably to a semifinished product. For instance, semifinished products of the invention with pastelike consistency may have an aluminum effect pigment/binder ratio of 8:1 to 1:2, preferably 6:1 to 1:1 (weight fractions).

In paints and printing inks, PVD aluminum pigments must always be formulated with a very low fraction of binder (resin, for example). The binder fraction is substantially lower than in corresponding formulations with conventional aluminum effect pigments. A higher binder fraction appears to disrupt the orientation behavior of the PVD pigments and, consequently, the advantageous optical properties of these pigments, such as the pronounced gloss and very good lightness flop, are reduced.

Formulations of this kind have the disadvantage, however, that their mechanical resistance, such as the abrasion resistance, for example, is lowered because of the low binder content.

A further advantage of the mixtures according to the invention is that, with formulations having a higher binder content than the usual systems developed for PVD aluminum effect pigments, optical properties are obtained that are virtually identical to those of systems pigmented with PVD pigments. By means of the mixtures according to the invention, therefore, mechanically more resistance formulations can be offered at a correspondingly more favorable price which, in optical terms, are comparable to PVD aluminum effect pigment formulations.

It has emerged, furthermore, that in coatings applications the mixtures according to the invention can be applied substantially more reproducibly, at different coating film thicknesses, in comparison to coating formulations which contain only PVD aluminum effect pigments. The result, ultimately, are coating formulations which in optical terms exhibit only slight detractions by comparison with PVD aluminum effect pigments, while having considerable performance advantages.

In the case of further-preferred embodiments, the mixture of aluminum effect pigments according to the invention further comprises additives. In this case the additives are taken preferably from the group consisting of dispersing additives, antisettling additives, anticorrosion additives, and mixtures thereof. Such additives are known to the skilled person.

In further preferred embodiments, the aluminum effect pigment mixtures of the invention are used in aqueous application systems. In these cases, therefore, the aluminum effect pigments in the mixture according to the invention are given a corrosion-inhibiting coating. The corrosion-inhibiting coating is taken from the group consisting of silicon oxides, silicon hydroxides, cerium oxide, boron oxide, chromating layers (EP 0 259 592 B1), aluminum oxides, hydroxides or oxide hydrates (e.g., DE 105 20 312 A1), crosslinked polymers (e.g., DE 4030727 A1, EP 1 837 380 A1, and EP 1 655 349 A1), inorganic/organic hybrid layers (e.g., EP 1 812 519 A2), and mixtures thereof and/or combinations thereof. It is, however, also possible to use other known stabilizing coatings, such as, for example, molybdates or vanadium compounds, alone or in conjunction with the techniques specified above. Also possible are all of the coatings specified in EP 0 826 745 A1.

Preferred as a corrosion-inhibiting coating are silicon oxides, silicon hydroxides, silicon oxide hydrates or chromating layers, and particularly preferred, on account of its very good effect and environmental compatibility, is a corrosion-inhibiting coating comprising silicon oxides, silicon hydroxides and/or silicon oxide hydrates.

In further-preferred embodiments the PVD Al aluminum effect pigments have no further colored layer or layers and no further layer or layers producing an interference color.

In even further-preferred embodiments the aluminum effect pigments conv. Al and the PVD Al aluminum effect pigments have no further colored layer or layers and/or no further layer or layers that generate an interference color. Preference, therefore, is given to mixtures of the aluminum effect pigments that produce a highly glossy silver impression, corresponding to the intrinsic color of the aluminum effect pigments.

A process for providing the mixture of aluminum effect pigments according to the invention comprises the following step:

Mixing PVD aluminum effect pigments and conv. Al aluminum effect pigments produced by milling, in the presence of solvent or a solvent mixture.

This process is suitable preferably for producing a precursor product or a semifinished product.

If, however, the desire is to incorporate the inventive mixture of aluminum effect pigments into the completed formulation, then it is also possible to incorporate the two aluminum effect pigment components into the formulation in succession. By this means, in certain circumstances, the shade tinting is better. The cost and complexity, however, are lower if the mixture according to the invention is incorporated in the form of a precursor product into the formulation.

The mixtures of aluminum effect pigments according to the invention find use in coatings, paints, printing inks, plastics or cosmetic formulations.

In the context of cosmetic formulations, nail varnishes are particularly preferred.

The present invention further provides coating compositions comprising a mixture of aluminum effect pigments as claimed in any of claims 1 to 11.

The coating compositions are preferably coatings, paints, printing inks, plastics or cosmetic formulations.

The article of the present invention has or comprises a coating composition as claimed in claim 14 or a mixture of aluminum effect pigments as claimed in any of claims 1 to 11.

The examples which follow illustrate the invention, but without restricting the scope of its protection.

### COMPARATIVE EXAMPLE 1

Here, a new thin aluminum effect pigment with a very thin thickness distribution was produced. The procedure adopted for this was as follows:

### a) Atomizing

In an induction crucible furnace (from Induga, furnace capacity around 2.5 tonnes), aluminum bars were continuously introduced and melted. In the forehearth, the aluminum melt, at a temperature of about 720° C., was in liquid form. A plurality of nozzles dipped into the melt and atomized the aluminum melt vertically upward. The atomizing gas was compressed to up to 20 bar in compressors (from Kaeser) and heated to up to about 700° C. in gas heaters. The resulting atomized aluminum powder solidified and cooled in flight. The induction furnace was integrated into a closed plant. Atomization took place under inert gas (nitrogen). The atomized aluminum powder was deposited first in a cyclone, where the atomized aluminum powder deposited therein had a d₅₀ of 14-17 μm. Further, downstream deposition was served by a multicyclone, and the atomized aluminum powder deposited in the multicyclone had a d₅₀ of 2.3-2.8 μm. Gas/solids separation took place in a filter (from Alpine) using metal elements. In this case, as an ultrafine fraction, an atomized aluminum powder having a d_{powder,Al,10} of 0.7 μm, a d_{powder,Al,50} of 1.9 μm, and a d_{powder,Al,90} of 3.8 μm was obtained.

### b) Milling:

A pot mill (length: 32 cm, width: 19 cm) was charged with 4 kg of glass balls (diameter: 2 mm), 75 g of the ultrafine atomized aluminum powder from the above step a), 200 g of white spirit, and 3.75 g of oleic acid. Milling then took place at 58 rpm for 15 hours. The product was separated from the grinding balls by rinsing with white spirit, and then was sieved through a 25 μm sieve in a wet sieving operation. The fine fraction was largely freed from white spirit on a suction filter, and then pasted up with white spirit in a laboratory mixer (approximately 30% by weight solids fraction).

### COMPARATIVE EXAMPLE 2

Commercially available PVD pigment dispersion Metalure L 55700 (from Eckart GmbH), PVD aluminum effect pigment dispersion with a metal pigment fraction of 10% by weight.

The size distributions of the pigments of the comparative examples were determined in a usual way by means of laser granulometry (Cilas 1064, Cilas, France).

The thickness distributions of the comparative examples were measured by means of SEM in accordance with the technique indicated by WO 2004/087816 A2. 97 pigment particles wee subjected to measurement in each case.

The results are set out in table 1.

TABLE 1
Physical characterization of the aluminum
effect pigments of the comparative examples

| | Size | | | Thickness | | | | |
|---|---|---|---|---|---|---|---|---|
| | distribution | | | distribution | | | Span | |
| | d₁₀ | d₅₀ | d₉₀ | h₁₀ | h₅₀ | h₉₀ | thick- | Form |
| Sample | [μm] | [μm] | [μm] | [nm] | [nm] | [nm] | nesses | factor |
| Comparative | 7.1 | 13.0 | 20.0 | 35 | 54 | 70.2 | 0.65 | 241 |
| example 1 | | | | | | | | |
| Comparative | 4.8 | 10.2 | 18.5 | 28 | 33 | 38 | 0.30 | 309 |
| example 2 | | | | | | | | |

### INVENTIVE EXAMPLES 1-5

### Mixtures of Comparative Examples 1 (Conv. Al) and Comparative Example 2 (PVD Al)

For this purpose, first of all the metallic effect pigment pastes from comparative examples 1 and 2 are mixed with one another. These mixed pastes were then incorporated into a coating system based on a nitrocellulose varnish. The solvent used was a mixture of isopropyl acetate, isopropanol, and methoxypropanol, and the coating formulation was admixed with minor additions of a fixing agent for the purpose of lowering the vapor pressure (0.4% by weight). The precise mixing proportions, weighed amounts of the pastes, and resultant solvent levels in the pastes are indicated in table 2.

The pigmented varnishes were drawn down onto contrast cards, using a 36 μm doctor, and then baked at 140° C. for 30 seconds.

The doctor drawdowns were characterized by a gloss measurement at 60° in a method based on DIN 67530 (instrument: micro-TR1-gloss from Byk-Gardner, D-82538 Geretsried, Germany). Calibration here took place by means of dark calibration and also by means of a black mirror glass plate with values of 92 for 60°.

The results of these measurements are likewise reported in table 2.

TABLE 2

| | Fraction of | Fraction of | Initial mass | Initial mass | Solvent content metallic | | Relative gloss |
|---|---|---|---|---|---|---|---|
| | conv. Al in | PVD Al in % | of paste, | of paste, | effect pigment paste or | Gloss | increase based |
| Sample | % by weight | by weight | conv. Al, in g | PVD Al in g | dispersion in % by weight | 60° | on pure conv. Al |
| Comparative | 0 | 100 | 0.0 | 3.0 | 90% | 212 | 100% |
| example 2 | | | | | | | |
| Example 1 | 20 | 80 | 0.43 | 2.57 | 87.2% | 200 | 81% |
| Example 2 | 40 | 60 | 1.20 | 1.80 | 85% | 190 | 66% |
| Example 3 | 50 | 50 | 0.75 | 2.25 | 82% | 184 | 56% |
| Example 4 | 60 | 40 | 1.00 | 2.00 | 83.3% | 173 | 39% |
| Example 5 | 80 | 20 | 1.71 | 1.29 | 78.9% | 172 | 37.5% |
| Comparative | 100 | 0 | 3.00 | 0.0 | 70% | 148 | 0% |
| example 1 | | | | | | | |

From table 2 it can be inferred that the solvent content of the aluminum effect pigment mixtures of the invention is lower in comparison to PVD aluminum. The gloss values of the mixtures, although lower, as expected, than those for PVD aluminum, nevertheless exhibit a significant increase in comparison to the conventional aluminum pigment. Calculated in the last column is the relative gloss increase, calculated according to the following formula:

Δgloss=100×(gloss value−148)/(212−148)

It is, surprisingly, virtually always higher than the percentage fraction of the PVD pigments in the aluminum effect pigment mixture. Thus, for a PVD pigment fraction of only 20% by weight, the relative gloss increase is already almost 40%.

1) A mixture of aluminum effect pigments
wherein the mixture comprises:
a) PVD aluminum effect pigments (PVD Al) which in a thickness distribution, as determined via thickness counting by scanning electron microscopy (SEM) and represented as cumulative frequency distribution, have an H_{50,PVD} value in a range from 10 nm to 70 nm,
b) aluminum effect pigments (conv. Al) which have been produced by milling methods and which in a thickness distribution, as determined via thickness counting by scanning electron microscopy (SEM) and represented as cumulative frequency distribution, have an h_{50,conv.} value in a range from 15 nm to 100 nm, and
c) a solvent or a solvent mixture,
with the proviso that the weight ratio of PVD Al to conv. Al is in a range from 99:1 to 1:99 and the solvent content is at least 30% by weight, based on the total weight of the mixture.

2) The mixture of aluminum effect pigments as claimed in claim 1, wherein the weight ratio of PVD Al to conv. Al is from 95:5 to 5:95.

3) The mixture of aluminum effect pigments as claimed in claim 1, wherein the aluminum effect pigments produced by milling methods have an h_{50,conv.} value of 20 nm to 75 nm.

4) The mixture of aluminum effect pigments as claimed in claim 1, wherein the aluminum effect pigments produced by milling methods, in a thickness distribution as determined via a thickness counting by scanning electronic microscopy and represented as cumulative frequency distribution, have a h_{90,conv.} value of 30 nm to 110 nm.

5) The mixture of aluminum effect pigments as claimed in claim 1, wherein the aluminum effect pigments produced by milling methods have a relative breadth of the thickness distribution, Δh, as determined via thickness counting by scanning electron microscopy and calculated on the basis of the corresponding cumulative frequency distribution of the relative frequencies, according to the formula
$$Δ h = 100 \times \frac{{h}_{90} - {h}_{50}}{{h}_{50}}$$
of 20% to 140%.

6) The mixture of aluminum effect pigments as claimed in claim 5, wherein the aluminum effect pigments produced by milling methods have a relative breadth of the thickness distribution, Δh, of from 30% to below 70%.

7) The mixture of aluminum effect pigments as claimed in claim 1, wherein the aluminum effect pigments of the mixture overall have a relative breadth of the thickness distribution, Δh, of from 20% to below 70%.

8) The mixture of aluminum effect pigments as claimed in claim 1, wherein the aluminum effect pigments of the mixture overall have an average particle size d_{50,M} of from 13 to 40 μm.

9) The mixture of aluminum effect pigments as claimed in claim 1, wherein the mixture of aluminum effect pigments has a solvent content of from 53% to 88% and an aluminum effect pigment fraction of from 45% to 12% by weight, based in each case on the total weight of the mixture.

10) The mixture of aluminum effect pigments as claimed in claim 1, wherein the mixture of aluminum effect pigments further comprises a binder.

11) The mixture of aluminum effect pigments as claimed in claim 10, wherein the weight ratio of the aluminum effect pigments to the binder is in a range from 8:1 to 1:15.

12) A process for preparing a mixture of aluminum effect pigments as claimed in claim 1,
wherein the process comprises:
mixing PVD aluminum effect pigments and aluminum effect pigments Al,conv. produced by milling, in the presence of a solvent or a solvent mixture.

13) A method for producing a material selected from the group consisting of coatings, paints, printing inks, plastics and cosmetic formulations, wherein the method comprises incorporating a mixture of aluminum effect pigments as claimed in claim 1 into said material.

14) A coating composition
wherein the coating composition comprises a mixture of aluminum effect pigments as claimed in claim 1.

15) A coated article
wherein the article comprises a coating composition as claimed in claim 14.

16) A coated article wherein the article comprises a mixture of aluminum effect pigments as claimed in claim 1.
